(19) United States
(12) Patent Application Publication
(10) Pub. No.: US 2008/0013030 A1
(43) Pub. Date: Jan. 17, 2008

(54) DISPLAY DEVICE WITH SUPPRESSED OCCURRENCE OF DISPLAY UNEVENNESS

(75) Inventor: Akira FUJITA, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD Technologies, Ltd., Kawasaki (JP)

(21) Appl. No.: 11/774,144

(22) Filed: Jul. 6, 2007

(30) Foreign Application Priority Data
Jul. 14, 2006 (JP) 2006-194543

(51) Int. Cl. G02F 1/1343; G02F 1/13

(52) U.S. Cl. 349/151; 349/187

(57) ABSTRACT

In a display device including a flexible base panel and a display panel mounted on the base panel, a drive circuit component is arranged on a periphery of and spaced away from the display panel and mounted on the base panel. A deformation suppression member is disposed on the base panel at a predetermined portion between the display panel and the drive circuit component.

This application is based upon and claims the benefit of priority from Japanese patent application No. 2006-194543, filed on Jul. 14, 2006, the disclosure of which is incorporated herein in its entirety by reference.

### BACKGROUND OF THE INVENTION

This invention relates to a display device such as, for example, a liquid crystal display device.

This type of display device is applied, for example, to a broadcasting station monitor, a medical image display apparatus, or the like. In the case where the environment of use is quite dark as in the application to the broadcasting station monitor, the recent liquid crystal display device is designed so that a slight difference in brightness on a display screen can be visually recognized more clearly as compared with that in a normal use environment.

A drive circuit component is used for driving such a display device. As a technique of mounting a drive circuit component, for example, in a liquid crystal display device, there is known a TCP (Tape Carrier Package) mounting method or a COF (Chip On Film) mounting method that connects, by bonding under heat and pressure, a film package, mounted with a drive IC (hereinafter abbreviated as an “IC”), to a flexible board through an anisotropic conductive film (hereinafter abbreviated as an “ACF”) serving as an adhesive. Recently, however, in response to requests for cost reduction and fine connection a COG (Chip On Glass) mounting method that directly mounts an IC itself on a board has been predominant. In a liquid crystal display device according to the COG mounting method, display unevenness due to glass strain occurs significantly as compared with the other mounting methods particularly at the time of dark screen display. Since a display image is affected by the display unevenness depending on use environment, an improvement in image quality is required from the user side.

FIG. 1 is a plan view showing a basic structure (the generally known basic structure but not according to an invention known by literature) of a liquid crystal display device manufactured according to the COG mounting method, FIG. 2 is an enlarged sectional view of only a main portion taken along line II-II in FIG. 1, and FIG. 3 is an enlarged sectional view of only a main portion taken along line III-III in FIG. 1.

In the liquid crystal display device shown in FIGS. 1 to 3, a display panel 10a made of flexible glass and having a smaller surface area is bonded to a base panel 10b made of the same glass and having a larger surface area so as to define a constant gap therebetween and a liquid crystal layer is interposed in the gap defined between the panels 10a and 10b, thereby forming a composite panel 10. An IC or ICs 2 as a single or a plurality of drive circuit components are fixedly mounted on the base panel 10b by bonding using an ACF 3, along the periphery of and spaced away from the display panel 10a.

On the base panel 10b, non-illustrated transistors, signal lines, scanning lines, pixel electrodes, and so on are disposed. Terminal electrodes 4 for connection to projecting electrodes 2a of the IC 2 are disposed at predetermined portions near the peripheral edge of the base panel 10b. The signal lines and scanning lines extend to the terminal electrodes 4 from a display surface of the display panel 10a. Because of the presence of conductive particles e contained in the ACF 3, the projecting electrodes 2a of the IC 2 are electrically connected to the terminal electrodes 4, respectively. The display panel 10a is provided with non-illustrated common electrodes and color layers.

FIG. 4 is a perspective view of a main portion (the structure shown in FIG. 1 of a later-described second patent document is partially modified) for explaining COG mounting processes in the manufacture of the foregoing liquid crystal display device.

At first, the ACF 3 is transferred onto the base panel 10b with the display panel 10a bonded thereto. The IC 2 is disposed on the ACF 3. Thereafter, a portion mounted with the IC 2 is placed on a pressure bonding stage 5 and sandwiched between the pressure bonding stage 5 and a pressure bonding tool 6 and, through heating and pressurization, the ACF 3 is cured. In this event, conductive particles e in the ACF 3 are sandwiched between the projecting electrodes 2a of the IC 2 and the terminal electrodes 4, thereby establishing electrical connection therebetween. Further, since the resin of the ACF 3 is cured, the IC 2 is fixedly bonded to the base panel 10b in the state where the electrical connection is maintained.

In the case of this COG mounting method, when bonding the IC 2 under heat and pressure, the IC 2 is often warped concavely due to a difference in thermal expansion between the IC 2 and the base panel 10b so as to be a defective. This is because, although the thermal expansion coefficient of the IC 2 is about 3 ppm and the thermal expansion coefficient of the base panel (glass panel) 10b is about 3.8 ppm and thus both are approximately equal to each other, the thermal capacity of the IC 2 is sufficiently small as compared with the total thermal capacity of the glass boards (the display panel 10a and the base panel 10b) so that the IC 2 is thermally expanded due to the heating by the pressure bonding tool 6, while, the thermal capacity of the base panel 10b is sufficiently large as compared with that of the IC 2 and further the portion where the IC 2 is mounted is suppressed in thermal deformation due to the bonded display panel 10a so that the base panel 10b is not thermally expanded. Further, the ACF 3 is generally made of thermosetting epoxy-based resin and thus is already cured when the temperature drops after the completion of the heat-pressure bonding, and therefore, the IC 2 is fixedly bonded to the base panel 10b by the ACF 3 in a thermally expanded state immediately after the heat-pressure bonding and then is deformed concavely due to contraction stress following the decrease in temperature.

It may happen that such warping of the IC 2 is transmitted to the base panel 10b through the ACF 3 and further reaches the display surface of the display panel 10a. If the gap for the liquid crystal layer locally changes due to this deformation strain, display unevenness occurs on the display surface at its portion neighboring the portion where the IC 2 is mounted, thereby causing degradation in display quality.

Particularly when a plurality of ICs 2 are arranged in a straight line on the base panel 10b along the periphery of the display panel 10a as shown in FIG. 1, the glass boards (the display panel 10a and the base panel 10b) are wavily deformed (FIG. 3 shows a deformed state of the base panel 10b). As the interval between the adjacent ICs 2 increases, the period of deformation increases to enlarge a range of display unevenness. Further, as the length dimension of each IC 2 in its longitudinal direction increases, the amplitude of deformation increases to intensify display unevenness.

There have been proposed some techniques for dealing with such display unevenness caused by the warping of the IC 2. For example, Japanese Unexamined Patent Application Publication (JP-A) No. 2001-51618 discloses a structure wherein a plurality of warp suppression pieces are disposed between mounted ICs and bonded under heat and pressure in the same manner as the ICs. The warp suppression pieces are made of a material having an elastic modulus equal to or greater than that of a glass board. By alternately arranging the warp suppression pieces between the ICs to restrict gaps between the adjacent ICs and warp suppression pieces in the longitudinal direction, the amplitude and period of IC warping can be reduced. As a result, the occurrence of display unevenness can be suppressed.

There have been also proposed a structure wherein aboard having -substantially the same shape as that of an IC is disposed on the back side of a glass board at a portion corresponding to an IC mounting portion (see Japanese Unexamined Patent Application Publication (JP-A) No. 2000-187234), a structure wherein a stress suppression board is disposed between an IC and a glass board and projecting electrodes of the IC and terminal electrodes of the glass board are mounted through a conductive portion of the stress suppression board using an ACF (see Japanese Unexamined Patent Application Publication (JP-A) No. 2002-76208), a structure wherein a display panel device uses an IC having a reinforcing member bonded to the back side of a circuit surface of the IC through a resin having a low elastic modulus (see Japanese Patent (JP-B) No. 3646677), and so on.

### SUMMARY OF THE INVENTION

In the case of Japanese Unexamined Patent Application Publication (JP-A) No. 2001-51618, the amplitude of warping that occurs between the ICs can be reduced, but the amplitude of warping increases with respect to the ICs mounted at the outermost positions to thereby cause occurrence of display unevenness. Further, although the degree of deformation toward a display surface decreases following the reduction in amplitude of warping, since a technique for preventing transmission of the deformation to the display surface is not considered, it cannot be a complete measure for display unevenness.

In the case of Japanese Unexamined Patent Application Publication (JP-A) No. 2000-187234, it is difficult to control stress balance between warping on the IC side and warping of the board disposed on the back side of the glass board. Further, the thickness of a display panel device increases by the thickness of the board serving to cancel the warping. In addition, no measure is taken for preventing the deformation of the glass board from being transmitted to a display surface.

In the case of Japanese Unexamined Patent Application Publication (JP-A) No. 2002-76208, the stress suppression board requires fine processing, thus leading to a large increase in cost. Further, since connection between the IC and the stress suppression board and connection between the stress suppression board and the glass board are respectively required, the yield decreases due to an increase in the number of fine connection points.

In the case of Japanese Patent (JP-B) No. 3646677, when bonding the IC to a glass board under heat and pressure, the adhesive serving to bond the reinforcing member to the IC also rises in temperature to soften and thus the reinforcing member cannot fully function. Further, since heat loss occurs because of the reinforcing member serving as a heat insulator, it is necessary to raise a setting temperature of a pressure bonding tool or to prolong a heating time, thus taking time for the heat-pressure bonding process. In addition, it is difficult to actually select the material properties such as thermal conductivity, thermal capacity, and thermal expansion coefficient of the reinforcing member and thermal resistance of the adhesive serving to fix the reinforcing member.

It is therefore an exemplary object of this invention to provide a display device having a simple structure that can stably suppress warping and prevent transmission of deformation strain to a display surface, thereby suppressing occurrence of display unevenness.

It is another exemplary object of this invention to provide a manufacturing method that can easily manufacture such a display device at low cost.

Other objects of the present invention will become clear as the description proceeds.

According to an exemplary aspect of the present invention, there is provided a display device compressing a flexible base panel, a display panel mounted on the base panel, a drive circuit component arranged on a periphery of and spaced away from the display panel and mounted on the base panel, and a deformation suppression member disposed on the base panel at a predetermined portion between the display panel and the drive circuit component.

According to another exemplary aspect of the present invention, there is provided a display device manufacturing method comprising bonding a display panel to a flexible base panel to form a composite panel, placing a drive circuit component on a periphery of and spaced away from the display panel and bonding the drive circuit component to the base panel, and placing a deformation suppression member at a predetermined portion between the display panel and the drive circuit component and bonding the deformation suppression member to the base panel.

### BRIEF DESCRIPTION OF THE DRAWINGS

FIG. 1 is a plan view showing a basic structure of a liquid crystal display device manufactured by the COG mounting method;

FIG. 2 is an enlarged sectional view of only a main portion taken along line II-II in FIG. 1;

FIG. 3 is an enlarged sectional view of only a main portion taken along line III-III in FIG. 1;

FIG. 4 is a perspective view for explaining COG mounting processes in the manufacture of the liquid crystal display device shown in FIG. 1;

FIG. 5 is a plan view showing a basic structure of a liquid crystal display device manufactured by a COG mounting method according to a first embodiment of this invention;

FIG. 6 is an enlarged sectional view of only a main portion taken along line VI-VI in FIG. 5;

FIG. 7 is a perspective view for explaining COG mounting processes in the manufacture of the liquid crystal display device shown in FIGS. 5 and 6;

FIG. 8 is a plan view showing a basic structure of a liquid crystal display device according to a second embodiment of this invention;

FIG. 9 is a plan view showing a basic structure of a liquid crystal display device according to a third embodiment of this invention;

FIG. 10 is a plan view showing a basic structure of a liquid crystal display device according to a fourth embodiment of this invention;

FIG. 11 is a plan view showing a basic structure of a liquid crystal display device according to a fifth embodiment of this invention;

FIG. 12 is a plan view showing a basic structure of a liquid crystal display device according to a sixth embodiment of this invention.

FIG. 13 is a plan view showing a basic structure of a liquid crystal display device according to a seventh embodiment of this invention;

FIG. 14 is a plan view showing a basic structure of a liquid crystal display device according to an eighth embodiment of this invention;

FIG. 15 is a plan view showing a basic structure of a liquid crystal display device according to a ninth embodiment of this invention;

FIG. 16 is a plan view showing a basic structure of a liquid crystal display device according to a tenth embodiment of this invention: and

FIGS. 17A and 17B are perspective views, respectively, for explaining a bonding process of a deformation suppression member in a manufacturing method of a liquid crystal display device according to an eleventh embodiment of this invention.

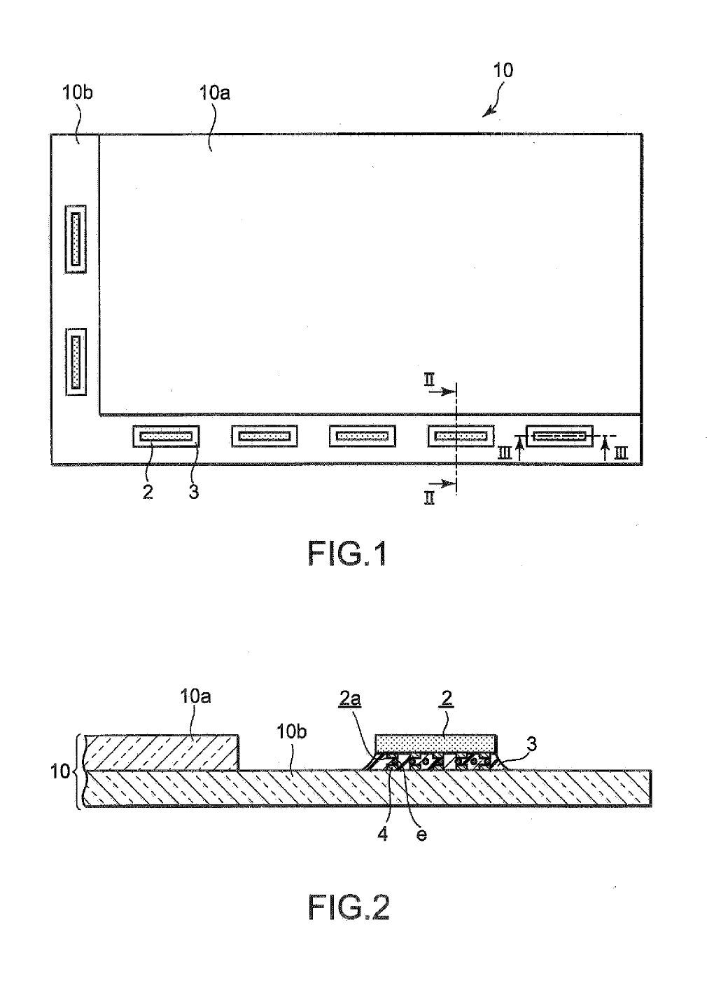

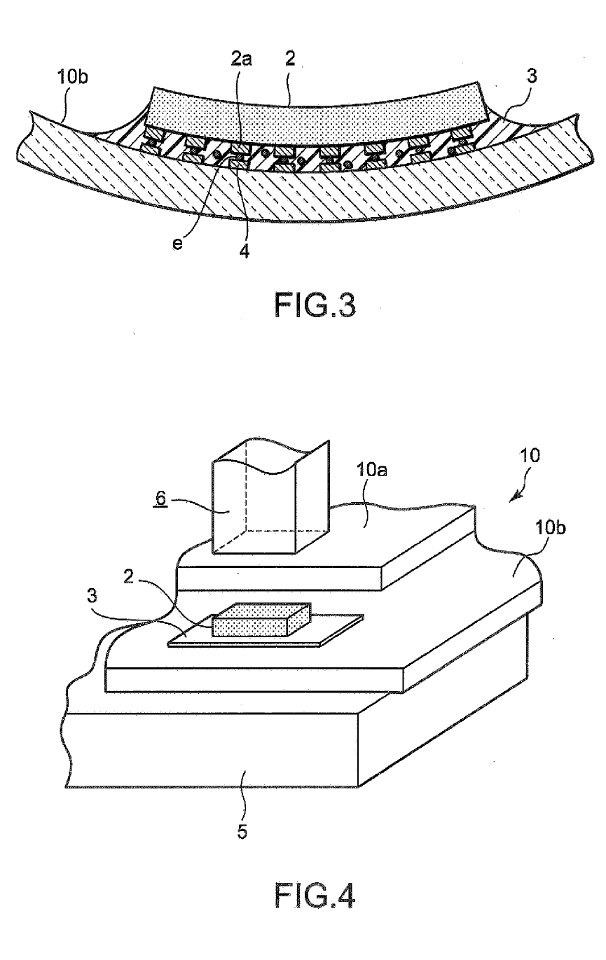

### DESCRIPTION OF THE EXEMPLARY EMBODIMENTS

Hereinbelow, description will be made about first through eleventh exemplary embodiments according to this invention.

### First Embodiment

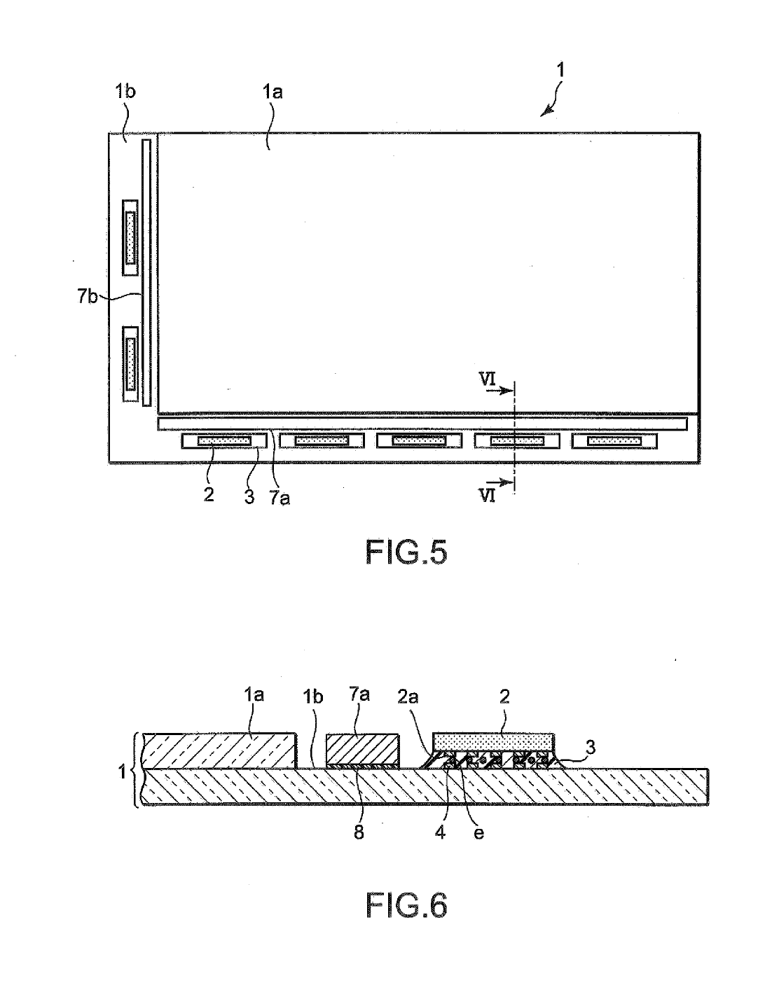

Referring to FIGS. 5 and 6, a liquid crystal display device according to the first embodiment will be described.

In the illustrated liquid crystal display device, a composite panel 1 comprises a base panel 1b made of flexible glass and having a relatively large surface area and a display panel 1a made of glass, having a relatively small surface areas and bonded to the base panel 1b with a constant gap defined therebetween. A liquid crystal layer is interposed in the gap between the base panel 1b and the display panel 1a. ICs 2 as a plurality of drive circuit components are disposed along the periphery of and spaced away from the display panel 1a, The ICs 2 are respectively fixedly bonded to the base panel 1b by an ACF 3.

Further, at predetermined portions on the base panel 1b between the display panel 1a and mounting portions of the ICs 2, quadrangular prism-shaped deformation suppression members 7a and 7b are bonded by an ordinary temperature-curable adhesive 8 along a longitudinal direction and a short-side direction of a display surface of the display panel 1a so as to cover the portions neighboring the side surfaces of the ICs 2 on the side of the display panel la. The deformation suppression members 7a and 7b are made of a material having a rigidity higher than that of the base panel 1b being the glass panels.

Hereinbelow, the liquid crystal display device will be described in further detail.

The thickness of each of the display panel 1a and the base panel 1b is 0.7 mm. The base panel 1b forms pixel electrodes and comprises a thin film transistor board (TFT board) having terminal electrodes 4 for electrical connection to the ICs 2. The display panel 1a comprises a color filter board (CF board) forming color layers and transparent common electrodes assigned to respective pixels. The composite panel 1 is in the form of the display panel 1a and the base panel 1b bonded together and is sandwiched between polarizing plates. Between the display panel 1a and the base panel 1b, the liquid crystal layer is sandwiched along with transistors, signal lines, scanning lines, pixel electrodes, and so on.

On the base panel 1b in its edge region not facing the display panel 1a, the terminal electrodes 4 are formed so as to extend from the signal lines, the scanning lines, and so on. The terminal electrodes 4 are electrically connected to projecting electrodes 2a of the ICs 2 serving as the external drive circuit components through the ACF 3. Each IC 2 has a generally rectangular shape with a thickness of 0.5 mm and is connected to the terminal electrodes 4 through the ACF 3 by bonding under heat and pressure and, in response to an input of an electrical signal from an external circuit board, sends an output signal to the display surface of the display panel 1a in the composite panel 1, thereby controlling a display screen.

The deformation suppression members 7a and 7b are bonded to the base panel 1b in a gap between the ICs 2 and the end surfaces of the display panel 1a by the adhesive. The deformation suppression members 7a and 7b are made of a material having a rigidity higher than those of the display panel 1a and the base panel 1b, such as, for example ceramic or metal. Herein, it is assumed that each of the deformation suppression members 7a and 7b is in the form of a ceramic member (ceramic board) having a length approximately equal to the corresponding side of the display panel 1a, a width of 1 mm, and a thickness of about 0.7 mm and is disposed with a gap of 0.2 mm from the display panel 1a and with a gap of 0.2 mm from each IC 2.

The gap between each of the deformation suppression members 7a and 7b and the display panel 1a is provided for avoiding occurrence of bonding failure of the deformation suppression member 7a, 7b due to glass projections or the like that are produced at the end portions of the display panel 1a in the manufacture of the composite panel 1. Therefore, unless such glass projections or the like are produced, the deformation suppression members 7a and 7b may be disposed in contact with, but not overlapping, the display panel 1a.

The gap between each of the deformation suppression members 7a and 7b and the ICs 2 is provided for avoiding interference with a pressure bonding tool at the time of heat-pressure bonding of the ICs 2. Therefore, if the sizes of each IC 2 and the pressure bonding tool are substantially equal to each other and thus the pressure bonding tool does not interfere with the deformation suppression member 7a, 7b, the deformation suppression members 7a and 7b may be disposed in contact with, but not overlapping, the IC 2.

The adhesive 8 has an adhesive strength that does not easily allow stripping against environmental changes in temperature, humidity, and so on required for the display device. Herein, it is assumed that use is made of an ordinary temperature-curable acrylic adhesive and its thickness after bonding is several μm to several tens of μm.

For enhancing the reinforcing effect for the deformation suppression members 7a and 7b, it is preferable to increase the width and thickness thereof. In order to avoid an increase in the total thickness of the composite panel 1, it is preferable that the sum total of the thickness of the adhesive 8 and the thickness of the deformation suppression member 7a, 7b be equal to or less than the sum total of the thickness of the display panel 1a and the thickness of the polarizing plate provided thereon.

As described above in detail, in the case of the liquid crystal display device according to the first embodiment, since the deformation suppression members 7a and 7b made of the material with the rigidity higher than those of the display panel 1a and the base panel 1b being the glass boards are disposed on the base panel 1b in the gap between the ICs 2 and the display panel 1a deformation of the glass boards (the display panel 1a and the base panel 1b) caused by the disposition of the ICs 2 can be prevented from being transmitted to the display surface of the display panel la. Consequently display unevenness on the display surface of the display panel 1a due to the glass board deformation can be stably suppressed.

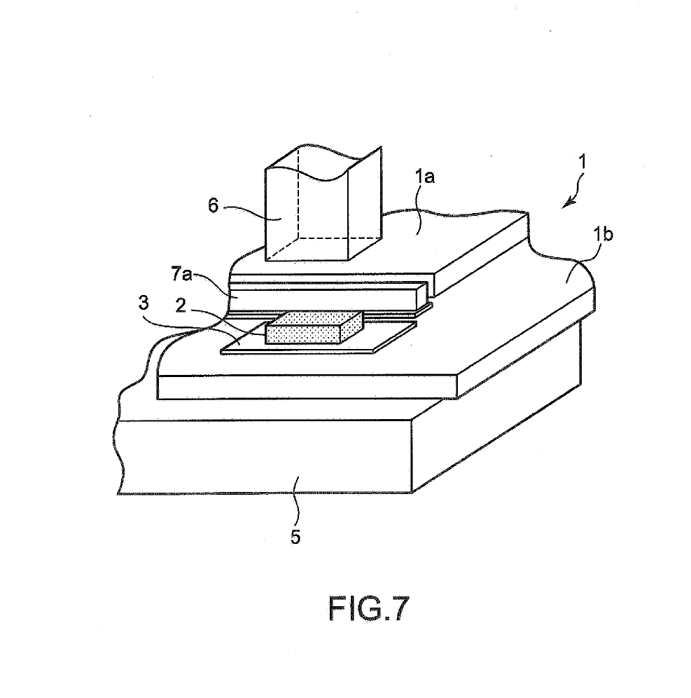

Referring to FIG. 7, a description will be given of COG mounting processes in the manufacture of the liquid crystal display device shown in FIGS. 5 and 6.

At first, on the base panel 1b in the composite panel 1, the adhesive 8 is transferred by a resin coating or printing method in a region that does not interfere with any of the terminal electrodes 4 and the display panel 1a. Then, the deformation suppression member 7a is disposed on the transferred adhesive 8 (actually, the deformation suppression member 7b is also processed in parallel in the same manner). In this event, for achieving firmer bonding by the adhesive 8, the bonding may be performed with a predetermined pressure and time using a press machine.

Then, the ACF 3 is transferred onto a portion, where the 1C 2 is to be mounted, of the terminal electrodes 4 formed on the base panel 1b with the display panel 1a bonded thereto. Subsequently, positioning is carried out to dispose the IC 2 on the ACF 3. Thereafter, a portion mounted with the IC 2 is placed on a pressure bonding stage 5 and sandwiched between the pressure bonding stage 5 and a pressure bonding tool 6 and, through heating and pressurization under the conditions of a predetermined temperature, pressure, and processing time adapted for heat-pressure bonding of the IC 2, the ACS 3 is cured. In this event, conductive particles e in the ACF 3 are sandwiched between the projecting electrodes 2a of the IC 2 and the terminal electrodes 4 due to the heating and pressurization, thereby establishing electrical connection therebetween. Further; since the resin of the ACF 3 Is cured, the IC 2 is fixedly bonded to the base panel 1b in the state where the electrical connection is maintained.

Actually, a flexible board and a circuit board are connected to the composite panel 1 thus manufactured and a backlight and a housing are further attached thereto, thereby completing a liquid crystal display device.

According to the liquid crystal display device of the first embodiment, the deformation suppression members 7a and 7b fixedly bonded to the base panel 1b have the higher rigidity than the display panel 1a and the base panel 1b being the glass boards and serve to locally strengthen the rigidity of the glass boards including peripheral portions of the deformation suppression members 7a and 7b. Since the heat-pressure bonding of each IC 2 is performed with respect to the composite panel 1 having the deformation suppression members 7a and 7b fixedly bonded thereto, even if the contraction stress occurs in the IC 2 due to the heat-pressure bonding, deformation of the glass boards is suppressed. Since the IC 2 disperses the contraction stress by deforming the glass boards, the internal stress that occurs in the ACF 3 increases by a suppressed portion of the deformation of the glass boards. However, since the ACF 3 has high flexibility and high connection reliability capable of absorbing it, the COG mounting herein raises no problem in terms of use.

Since the deformation of the glass boards is suppressed by the deformation suppression members 7a and 7b, the deformation strain of the glass boards transmitted toward the display surface of the display panel 1a in the composite panel 1 decreases, Further, since the deformation suppression members 7a and 7b are provided in the gap between the display panel 1a and the ICs 2, the transmission of the glass board deformation is further suppressed so that substantially no glass board deformation occurs on the side of the display surface beyond the deformation suppression members 7a and 7b.

Therefore, in the case of the liquid crystal display device according to the first embodiment, the local gap change at the crystal layer does not occur and thus it is possible to suppress occurrence of display unevenness on the display surface of the display panel 1a in the composite panel 1, thereby obtaining the high-quality product. The deformation suppression member can achieve higher display unevenness suppression effect as the rigidity thereof increases in terms of its purpose and may be subjected to various modifications in shape and layout, which will be described hereinbelow as other embodiments of this invention.

### Second Embodiment

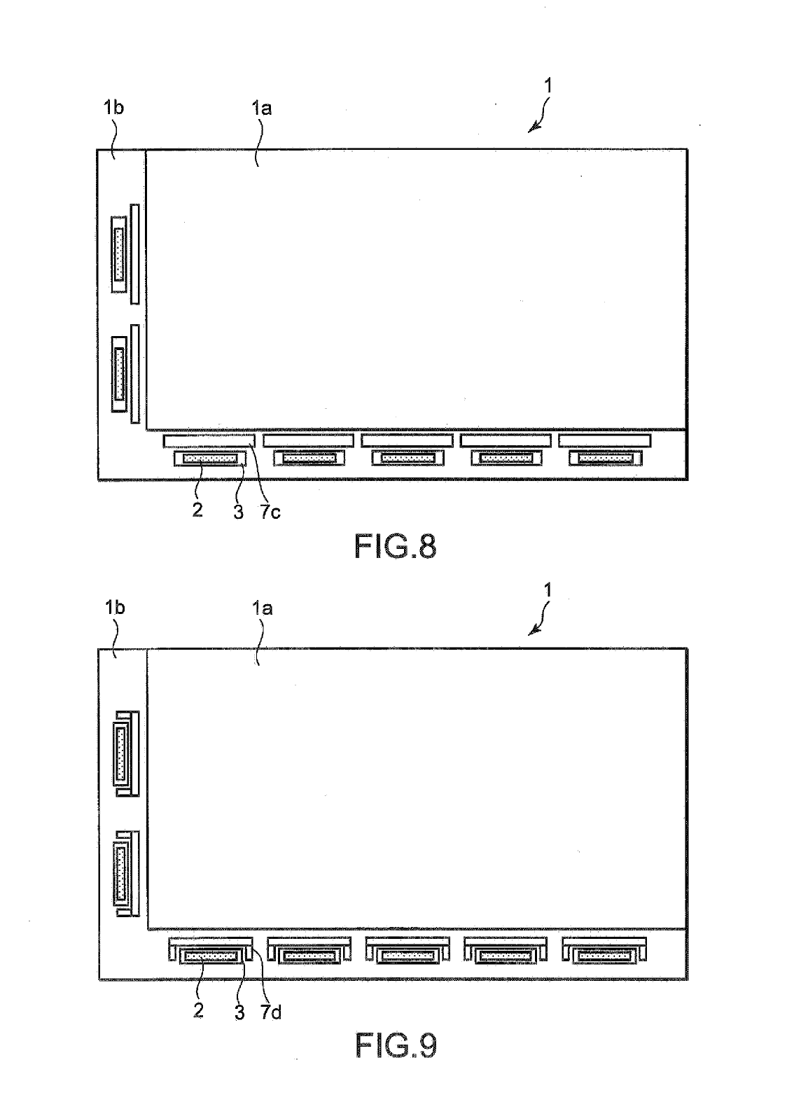

Referring to FIG. 8, a liquid crystal display device according to the second embodiment will be described. The same portions are assigned the same reference symbols, thereby omitting explanation thereof;

The liquid crystal display device of FIG. 8 is the same in basic structure as the foregoing first embodiment. However, while use is made of the two quadrangular prism-shaped deformation suppression members 7a and 7b each being continuous and having the length approximately equal to the corresponding side of the display panel 1a in the first embodiment, quadrangular prism-shaped deformation suppression members 7c each having a length somewhat longer than that of the IC 2 in its longitudinal direction are disposed in one-to-one correspondence with the ICs 2 in the second embodiment. Thus, the number of the deformation suppression members 7c is equal to the number of the ICs 2.

According to the liquid crystal display device of the second embodiment, as compared with the deformation suppression member 7a, 7b in the first embodiment, each deformation suppression member 7c has the same cross-sectional shape but is higher in flexural rigidity because of its shorter length, thereby exhibiting higher display unevenness suppression effect.

### Third Embodiment

Referring to FIG. 9, a liquid crystal display device according to the third embodiment will be described. The same portions are assigned the same reference symbols, thereby omitting explanation thereof.

The liquid crystal display device of FIG. 9 is the same in basic structure as the foregoing first embodiment. In the foregoing second embodiment, each of the deformation suppression members 7c provided in one-to-one correspondence with the ICs 2 surrounds the corresponding IC 2 only on the side of the display panel 1a. On the other hand, in the third embodiment, each of deformation suppression members 7d surrounds the side periphery of the corresponding a IC 2 in three directions except its outward direction such that the sectional shape of the deformation suppression member 7d in the same plane as the display surface in the height direction is a generally U-shape.

According to the liquid crystal display device of the third embodiment, since use is made of the deformation suppression member 7d having the generally U-shaped section, the flexural rigidity is further improved as compared with the deformation suppression member 7c and thus the deformation of the glass boards can be stably suppressed, thereby exhibiting excellent display unevenness suppression effect.

### Fourth Embodiment

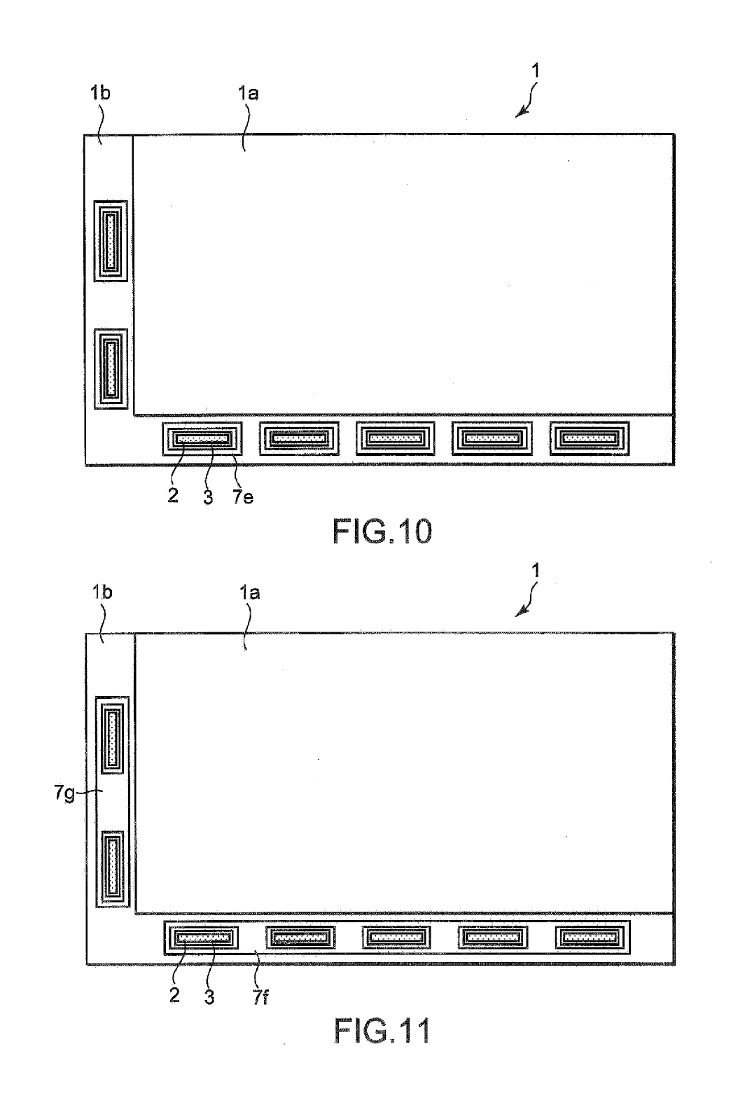

Referring to FIG. 10, a liquid crystal display device according to the fourth embodiment will be described. The same portions are assigned the same reference symbols, thereby omitting explanation thereof.

The liquid crystal display device of FIG. 10 is the same in basic structure as the foregoing first embodiment. In the foregoing third embodiment, each of the deformation suppression members 7d provided in one-to-one correspondence with the ICs 2 is generally U-shaped in section to surround the three sides of the periphery of the corresponding IC 2. On the other hand, in the fourth embodiment, each of deformation suppression members 7e surrounds the side periphery of the corresponding IC 2 in its all directions such that the sectional shape of the deformation suppression member 7e in the same plane as the display surface in the height direction is a generally frame shape.

According to the liquid crystal display device of the fourth embodiment, since use is made of the deformation suppression member 7e having the generally frame-shaped section, the flexural rigidity is further improved as compared with the deformation suppression member 7d and thus the deformation of the glass boards can be very stably suppressed, thereby exhibiting extremely excellent display unevenness suppression effect. Such a deformation suppression member 7e surrounding all the side periphery of the IC 2 is particularly preferable when the thickness of a deformation suppression member cannot be sufficiently ensured such as when the IC 2 is of a thin type or when the size of a pressure bonding tool is larger than that of the IC 2 to be pressure-bonded so that the deformation suppression member and the pressure bonding tool interfere with each other. This is because even if the deformation suppression member 7e is thin, high flexural rigidity can be effectively obtained by taking the shape that surrounds all the side periphery of the IC 2.

### Fifth Embodiment

Referring to FIG. 11, a liquid crystal display device according to the fifth embodiment will be described. The same portions are assigned the same reference symbols thereby omitting explanation thereof.

The liquid crystal display device of FIG. 11 is the same in basic structure as the foregoing first embodiment. In the liquid crystal display device of the fifth embodiment, the deformation suppression members 7e provided in one-to-one correspondence with the ICs 2 in the foregoing fourth embodiment are modified and use is made of two integrally-structured deformation suppression members 7f and 7g extending along the longitudinal direction and the short-side direction of the display surface of the display panel 1a, respectively, as in the case of the first embodiment. These deformation suppression members 7f and 7g can each be regarded as one obtained by joining the deformation suppression members 7e of the fourth embodiment into the integral structure.

According to the liquid crystal display device of the fifth embodiment, since the deformation suppression members 7e can be collectively disposed on the base panel 1b, the productivity can be improved particularly when the number of ICs 2 to be disposed is large.

### Sixth Embodiment

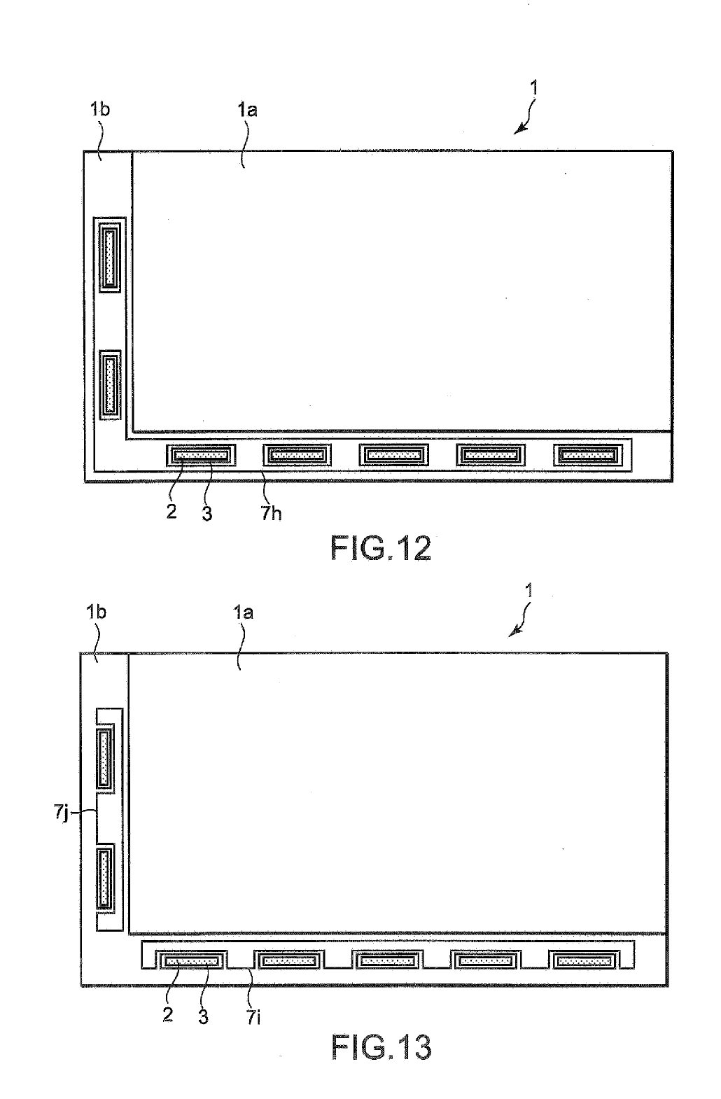

Referring to FIG. 12, a liquid crystal display device according to the sixth embodiment will be described. The same portions are assigned the same reference symbols, thereby omitting explanation thereof.

The liquid crystal display device of FIG. 12 is the same in basic structure as the foregoing first embodiment. In the liquid crystal display device of the sixth embodiment, the two deformation suppression members 7f and 7g according to the foregoing fifth embodiment are modified and use is made of a single L-shaped deformation suppression member 7h obtained by joining the deformation suppression members 7f and 7g into the fully integral structure. The deformation suppression member 7h is formed such that the deformation suppression members 7f and 7g of the fifth embodiment divided per side of the display panel 1a on the base panel 1b are integrated into a generally L-shape, thereby further improving the productivity. The deformation suppression member 7h includes a connecting portion that connects between the ICs 2 located at the outermost ends of the ICs 2 disposed in mutually perpendicular straight lines along the periphery of the display panel 1a, near a corner of the display panel 1a.

### Seventh Embodiment

Referring to FIG. 13, a liquid crystal display device according to the seventh embodiment will be described. The same portions are assigned the same reference symbols, thereby omitting explanation thereof.

The liquid crystal display device of FIG. 13 is the same in basic structure as the foregoing first embodiment. In the liquid crystal display device of the seventh embodiment, the deformation suppression members 7d according to the foregoing third embodiment are modified and use is made of two integrally-structured deformation suppression members 7i and 7j extending along the longitudinal direction and the short-side direction of the display surface of the display panel 1a, respectively, as in the case of the first embodiment. These deformation suppression members 7i and 7j can each be regarded as one obtained by joining the deformation suppression members 7d of the third embodiment into the integral structure.

According to the liquid crystal display device of the seventh embodiment, since the deformation suppression members 7d can be collectively disposed on the base panel 1b, the productivity can be improved particularly when the number of ICs 2 to be disposed is large.

### Eighth Embodiment

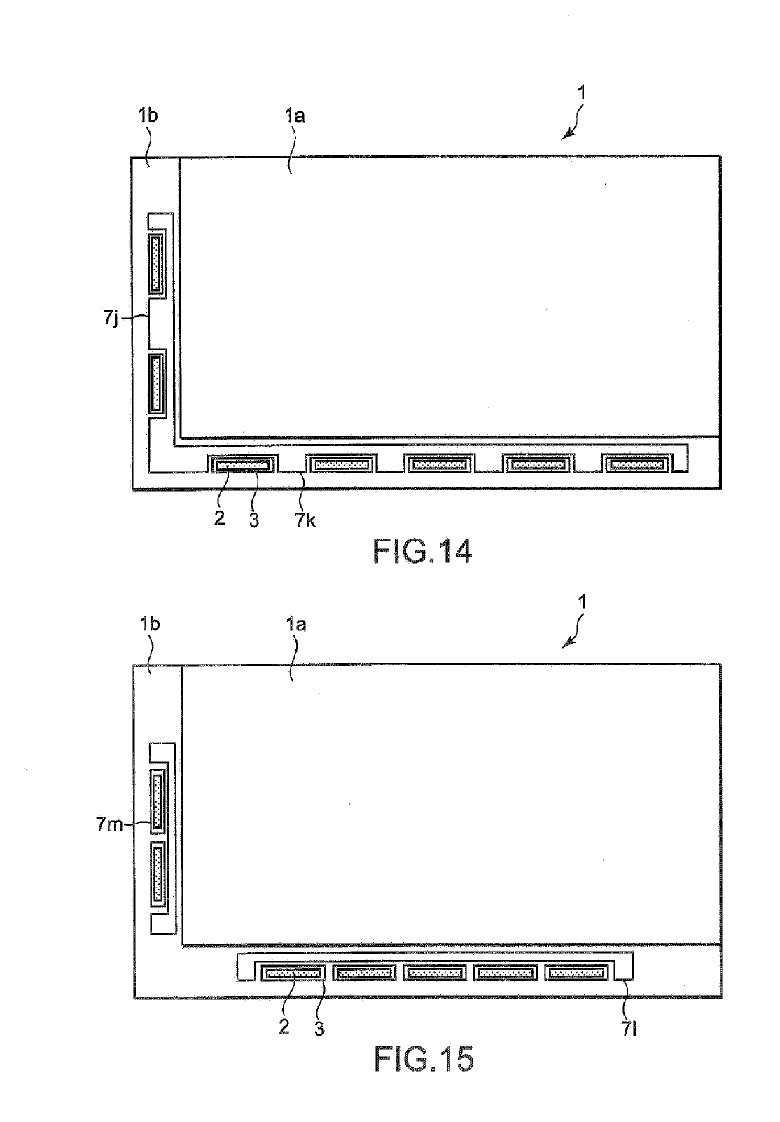

Referring to FIG. 14, a liquid crystal display device according to the eighth embodiment will be described. The same portions are assigned the same reference symbols, thereby omitting explanation thereof.

The liquid crystal display device of FIG. 14 is the same in basic structure as the foregoing first embodiment. In the liquid crystal display device of the eighth embodiment, the two deformation suppression members 7i and 7j according to the foregoing seventh embodiment are modified and use is made of a single L-shaped deformation suppression member 7k obtained by joining the deformation suppression members 7i and 7j into the fully integral structure. The deformation suppression member 7k is formed such that the deformation suppression members 7l and 7j of the seventh embodiment divided per side of the display panel 1a on the base panel 1b are integrated into a generally L-shape, thereby further improving the productivity. The deformation suppression member 7k includes a connecting portion that connects between the ICs 2 located at the outermost ends of the ICs 2 disposed in mutually perpendicular straight lines along the periphery of the display panel 1a, near a corner of the display panel 1a.

### Ninth Embodiment

Referring to FIG. 15, a liquid crystal display device according to the ninth embodiment will be described The same portions are assigned the same reference symbols, thereby omitting explanation thereof.

The liquid crystal display device of FIG. 15 is the same in basic structure as the foregoing first embodiment. In the liquid crystal display device of the ninth embodiment, as a countermeasure for the case where, in the application of the deformation suppression members 7i and 7j or the deformation suppression member 7k described in the foregoing seventh or eighth embodiment, a space between the adjacent ICs 2 is narrow so that a portion of the deformation suppression member cannot be disposed in the region facing the short sides of the adjacent ICs 2, use is made of two deformation suppression members 7l and 7m each having a shape to surround both outer end portions of an array of the ICs 2 along the longitudinal direction or an array of the ICs 2 along the short-side direction (a group of the ICs 2 along the longitudinal direction or a group of the ICs 2 along the short-side direction) of the display surface of the display panel 1a.

According to the liquid crystal display device of the ninth embodiment, the deformation suppression members 7l and 7m can each be collectively disposed on the base panel 1b so as to surround the mutually juxtaposed ICs 2 on the side of the display panel 1a and further surround the side periphery of the ICs 2 located at the opposite outermost ends. Therefore, the productivity can be improved particularly when a large number of ICs 2 are disposed at high density.

### Tenth Embodiment

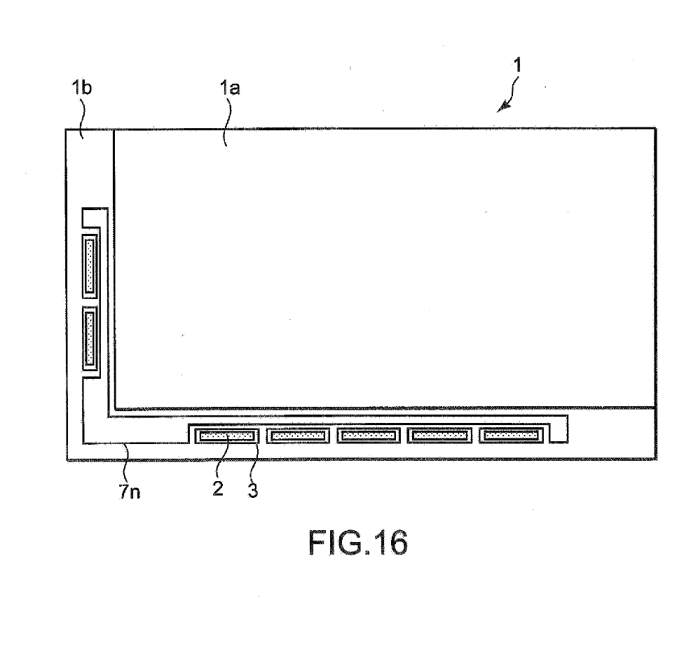

Referring to FIG. 16, a liquid crystal display device according to the tenth embodiment will be described. The same portions are assigned the same reference symbols, thereby omitting explanation thereof.

The liquid crystal display device of FIG. 16 is the same in basic structure as the foregoing first embodiment. In the liquid crystal display device of the tenth embodiment, the two deformation suppression members 7l and 7m according to the foregoing ninth embodiment are modified and use is made of a single L-shaped deformation suppression member 7n obtained by joining the deformation suppression members 7l and 7m into the fully integral structure. The deformation suppression member 7n is formed such that the deformation suppression members 7l and 7m of the ninth embodiment divided per side of the display panel 1a on the base panel 1b are integrated into a generally L-shape, thereby further improving the productivity. The deformation suppression member 7n includes a connecting portion that connects between the ICs 2 located at the outermost ends of the ICs 2 disposed in mutually perpendicular straight lines along the periphery of the display panel 1a, near a corner of the display panel 1a.

In the foregoing embodiments 1 to 10, the deformation suppression members 7a to 7n are made of the material having the rigidity higher than those of the glass boards, i.e. the display panel 1a and the base panel 1b, forming the composite panel 1. However, instead of it, a glass material having the same rigidity may be used. Further, the ordinary temperature-curable acrylic adhesive is used as the adhesive 8 for fixing the deformation suppression members 7a to 7n onto the base panel 1b. However, instead of it, use may be made of a thermosetting seal adhesive made of thermosetting epoxy resin or the like for use in bonding together the display panel 1a and the base panel b, or other seal adhesives.

In the case where, for example, a TCP distinguished from the IC 2 is bonded under heat and pressure as a drive circuit component using the ACF 3, a plurality of TOPs arranged along the same side of the display panel 1a are generally collectively bonded. Since the TCP is thinner than the IC 2 and is further thinner than the deformation suppression member, when using the deformation suppression members 7d to 7n having the shapes shown in the embodiments 3 to 10, it is preferable to dispose the deformation suppression members 7d to 7n after bonding the TOPs in order to prevent interference with a pressure bonding tool. Incidentally, in the case of the TCP mounting structure, the deformation suppression members 7a to 7d having the shapes shown in the embodiments 1 to 3 and the deformation suppression members 7i to 7n having the shapes shown in the embodiments 7 to 10 are actually applicable. On the other hand, when drive circuit components are ICs, the deformation suppression members 7a to 7n having the shapes shown in all the embodiments 1 to 10 are applicable. In any event, as described in the embodiments 1 to 10, the deformation suppression members 7a to 7n serve to suppress the deformation of the glass boards that occurs at the time of heat-pressure bonding of the drive circuit components, but it is possible to achieve the same effect even if the deformation of the glass boards is corrected after the heat-pressure bonding of the drive circuit components.

When manufacturing the liquid crystal display device according to any of the foregoing embodiments 1 to 10, the composite panel forming process of seat-bonding the display panel 1a to the flexible base panel 1b to thereby form the composite panel 1 and the drive circuit component disposing process of disposing, by bonding, the drive circuit components (ICs 2) on the base panel 1b along the periphery of and spaced away from the display panel 1a are basically performed and, further, the deformation suppression member disposing process may be performed to dispose, by bonding, the deformation suppression members 7a to 7n (wholly or partly) at the predetermined portion on the base panel 1b between the display panel 1a and the mounting portions of the drive circuit components (ICs 2). Note that the bonding of the deformation suppression members 7a to 7n in the deformation suppression member disposing process is carried out simultaneously with the seal bonding of the display panel 1a In the composite panel forming process. The seal bonding of the display panel 1a in the composite panel forming process and the bonding of the deformation suppression members 7a to 7n in the deformation suppression member disposing process may be performed using the same bonding material.

### Eleventh Embodiment

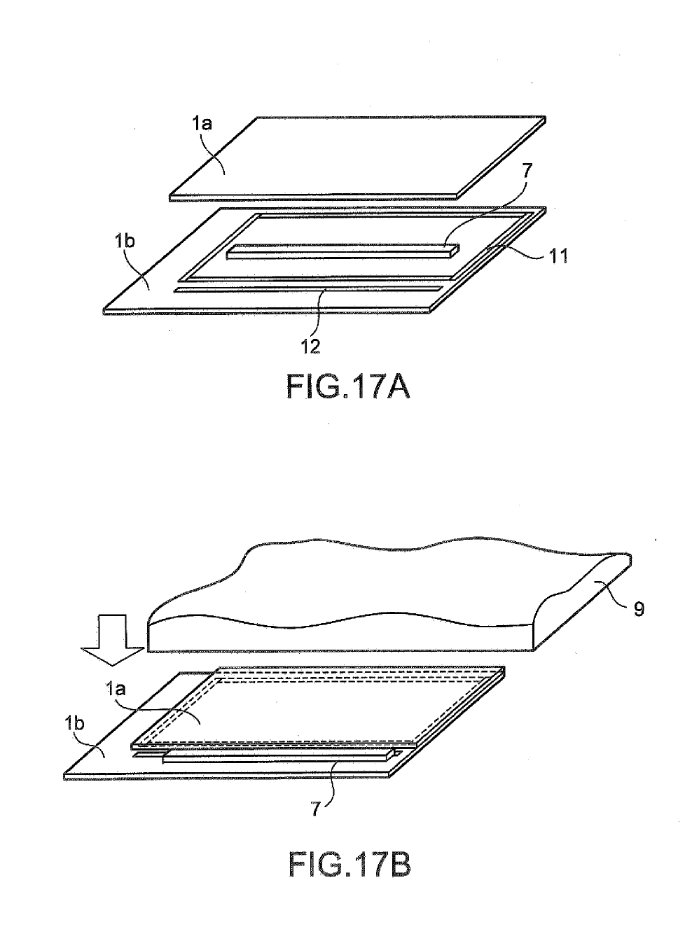

Now, referring to FIGS. 17A and 17B, a description will be given of a deformation suppression member bonding process in a manufacturing method of a liquid crystal display device according to the eleventh embodiment.

FIG. 17A shows a first-half process of the bonding process. In this first-half process, when bonding together the display panel 1a and the base panel 1b, a seat adhesive 11 is transferred in advance on the base panel 1b in a predetermined region where the display panel 1a is to be bonded, using a printing or coating method. Simultaneously with this, a seal adhesive 12 is transferred also sin a region where a deformation suppression member 7 is to be bonded. In this manner, it is arranged that the display panel 1a can be placed on the seal adhesive 11 and the deformation suppression member 7 can be placed on the seal adhesive 12.

FIG. 17B shows a latter-half process of the bonding process. In this latter-half process, the display panel 1a is placed in the region of the seal adhesive 11 on the base panel 1b and, on the periphery thereof the deformation suppression member 7 is placed in the region of the seal adhesive 12 on the base panel 1b. Thereafter the base panel 1b with the deformation suppression member 7 and the display panel 1a placed thereon is applied with a pressure for a predetermined time by a press machine (pressed by a pressing plate 9 in a direction of an outline arrow) in a burning furnace maintained at a predetermined temperature, thereby bonding the deformation suppression member 7 and the display panel 1a to the base panel 1b. Herein, since the deformation suppression member 7 and the display panel 1a have the same thickness, the deformation suppression member 7 and the display panel 1a are pressed together by the pressing plate 9 of the press machine to be fixedly bonded to the base panel 1b.

Further, liquid crystals are filled between the display panel 1a and the base panel 1b bonded together by the seal adhesive 11 and sealing is performed and, then, non-illustrated polarizing plates are bonded thereto, thereby completing the manufacture of the composite panel 1.

As described above, the bonding process of the deformation suppression member 7 (corresponding to the foregoing deformation suppression member disposing process) is carried out simultaneously with the bonding process of the display panel 1a and the base panel 1b (corresponding to the foregoing composite panel forming process).

Subsequently, a liquid crystal display device is manufactured based on the obtained composite panel 1. Since subsequent processes are the same as the conventional processes, the liquid crystal display device with high image quality can be manufactured by the low-cost and simple means While the liquid crystal display devices have been described in the foregoing exemplary embodiments 1 to 11 this invention is not limited thereto, but may also be applied to a plasma display device, an organic EL display device, and so on. Further, this invention is not limited to the COG mounting, but may also be applied to the TCP mounting, the COF mounting, and so on. Specifically, this invention is applicable to any mounting structure in which a difference in thermal expansion between a glass board and a drive circuit component causes deformation o the glass board or a gap change due to heat-pressure bonding by the ACF 3 to thereby affect a display surface.

In the display device, the drive circuit component may comprises a single or a plurality of rectangular plate-shaped drive circuit components and the deformation suppression member comprises a single or a plurality of deformation suppression members surrounding the side periphery of the single or plurality of drive circuit components at least on the side of the display panel on the base panel.

In the display device, the single or plurality of deformation suppression members may surround the side periphery of the single or plurality of drive circuit components fin three directions except an outward direction on the base panel.

In the display device, the single or plurality of deformation suppression members may surround the side periphery of the drive circuit components located at outermost ends of the mutually juxtaposed drive circuit components on the base panel.

In the display device, the single or plurality of deformation suppression members may surround the side periphery of the single or plurality of drive circuit components in all directions on the base panel.

In the display device, the single deformation suppression member may includes a connecting portion that connects between the drive circuit components located at outermost ends of the drive circuit components disposed in mutually crossing straight lines on the base panel along the periphery of the display panel, near a corner of the display panel.

In the display device, the base panel may be a glass panel and the deformation suppression member has a rigidity higher than that of the glass panel.

In the display device, the deformation suppression member may be bonded to the base panel by an ordinary temperature-curable adhesive.

In the display device, a bonding material bonding the display panel and a bonding material bonding the deformation suppression member may be of the same kind.

In the method of manufacturing the display device, bonding of the display panel and bonding of the deformation suppression member may be performed using the same kind of bonding material.

In the method of manufacturing the display device, the bonding of the display panel and the bonding of the deformation suppression member may be performed simultaneously.

In each of the foregoing display devices, it may be possible to locally strengthen the rigidity of the glass boards (the base panel and the display panels, to suppress or correct warping of the drive circuit component such as the IC that occurs at the time of heat-pressure bonding thereof and further to suppress transmission of deformation to the glass boards, thus capable of preventing the local gap change at the liquid crystal layer. Therefore, it is possible to reduce display unevenness on the display surface of the display panel to thereby provide the high-quality display device. Particularly, if the deformation suppression member is made of a material having a rigidity higher than that of the base panel, the rigidity of the glass boards can be locally strengthened and thus the deformation of the glass boards at the time of heat-pressure bonding of the drive circuit component can be more stably suppressed.

While the present invention has thus far been described in connection with a few embodiments thereof, it will readily be possible for those skilled in the art to put this invention into practice in various other manners,

What is claimed is:

1. A display device comprising:
a flexible base panel;
a display panel mounted on said base panel;
a drive circuit component arranged on a periphery of and spaced away from said display panel and mounted on said base panel; and
a deformation suppression member disposed on said base panel at a predetermined portion between said display panel and said drive circuit component.

2. The display device according to claim 1, wherein said drive circuit component comprises a single or a plurality of rectangular plate-shaped drive circuit components and said deformation suppression member comprises a single or a plurality of deformation suppression members surrounding the side periphery of said single or plurality of drive circuit components at least on the side of said display panel on said base panel.

3. The display device according to claim 2, wherein said single or plurality of deformation suppression members surround the side periphery of said single or plurality of drive circuit components in three directions except an outward direction on said base panel.

4. The display device according to claim 2, wherein said single or plurality of deformation suppression members surround the side periphery of the drive circuit components located at outermost ends of the mutually juxtaposed drive circuit components on said base panel.

5. The display device according to claim 2, wherein said single or plurality of deformation suppression members surround the side periphery of said single or plurality of drive circuit components in all directions on said base panel.

6. The display device according to claim 2, wherein said single deformation suppression member includes a connecting portion that connects between the drive circuit components located at outermost ends of the drive circuit components disposed in mutually crossing straight lines on said base panel along the periphery of said display panel, near a corner of said display panel.

7. The display device according to claim 1, wherein said base panel is a glass panel and said deformation suppression member has a rigidity higher than that of said glass panel.

8. The display device according to claim 1, wherein said deformation suppression member is bonded to said base panel by an ordinary temperature-curable adhesive.

9. The display device according to claim 1, wherein a bonding material bonding said display panel and a bonding material bonding said deformation suppression member are of the same kind.

10. A method of manufacturing a display device, comprising.
bonding a display panel to a flexible base panel to form a composite panel;
placing a drive circuit component on a periphery of and spaced away from said display panel and bonding said drive circuit component to said base panel; and
placing a deformation suppression member at a predetermined portion between said display panel and said drive circuit component and bonding said deformation suppression member to said base panel.

11. The method according to claim 10, wherein bonding of said display panel and bonding of said deformation suppression member are performed using the same kind of bonding material.

12. The method according to claim 11 wherein the bonding of said display panel and the bonding of said deformation suppression member are performed simultaneously
